(19) United States
(12) Patent Application Publication
(10) Pub. No.: US 2026/0141851 A1
(43) Pub. Date: May 21, 2026

(54) PIXEL OF A DISPLAY DEVICE, DISPLAY DEVICE AND ELECTRONIC DEVICE

(71) Applicant: Samsung Display Co., Ltd., Yongin-si (KR)

(72) Inventors: DONGWOO KIM, Yongin-si (KR); KYUNG-BAE KIM, Yongin-si (KR); YEONKYUNG KIM, Yongin-si (KR); YONGHEE LEE, Yongin-si (KR)

(21) Appl. No.: 19/274,312

(22) Filed: Jul. 18, 2025

(30) Foreign Application Priority Data
Nov. 20, 2024 (KR) 10-2024-0166255

(51) Int. Cl. G09G 3/3233; G09G 3/32

(52) U.S. Cl. CPC G09G 3/3233; G09G 3/32; G09G 2300/043; G09G 2300/0819; G09G 2310/08; G09G 2320/0257; G09G 2330/022

(57) ABSTRACT

A pixel of a display device includes a first transistor including a gate connected to a first node, a first terminal configured to receive a first power supply voltage, and a second terminal connected to a second node, a first capacitor including a first electrode configured to receives the first power supply voltage, and a second electrode connected to the first node, a second capacitor including a first electrode connected to a third node, and a second electrode connected to the first node, a second transistor configured to transfer a data voltage to the third node in response to a first signal, a third transistor configured to connect the first node and the second node to each other in response to a second signal, a fourth transistor configured to connect the first node and the third node to each other in response to a third signal.

### CROSS-REFERENCE TO RELATED APPLICATION

This application claims priority to and the benefit of Korean Patent Application No. 10-2024-0166255, filed on Nov. 20, 2024, in the Korean Intellectual Property Office, the entire disclosure of which is incorporated by reference herein.

### BACKGROUND

### 1. Field

The present disclosure relates to a display device, and more particularly to a pixel, a display device including the pixel, and an electronic device including the display device.

### 2. Description of the Related Art

A pixel of a display device, such as an organic light-emitting diode (“OLED”) display device, may include a light-emitting element, a storage capacitor, and a plurality of transistors. For example, the pixel may include seven transistors, including a driving transistor for generating a driving current, a scan transistor for transferring a data voltage, a compensation transistor for diode-connecting the driving transistor, an initialization transistor for applying an initialization voltage to a gate node, emission transistors for forming a path for the driving current, and an anode initialization transistor for applying the initialization voltage to an anode of the light-emitting element. However, in order to increase a resolution of the display device, the number of transistors included in the pixel and the number of signals applied to the transistors should be reduced.

Further, a conventional pixel is formed on a glass substrate, but a display device in which a pixel is formed on a flexible semiconductor substrate has been recently developed. However, the pixel formed on the semiconductor substrate may have a narrower data voltage range compared with the conventional pixel.

### SUMMARY

Some embodiments of the present disclosure provide a pixel of a display device having a small number of transistors and capable of increasing a data voltage range.

Some embodiments of the present disclosure provide a display device including the pixel.

Some embodiments provide an electronic device including the display device.

According to one or more embodiments, there is provided a pixel of a display device. The pixel includes a first transistor including a gate connected to a first node, a first terminal configured to receive a first power supply voltage, and a second terminal connected to a second node, a first capacitor including a first electrode configured to receive the first power supply voltage, and a second electrode connected to the first node, a second capacitor including a first electrode connected to a third node, and a second electrode connected to the first node, a second transistor configured to transfer a data voltage to the third node in response to a first signal, a third transistor configured to connect the first node and the second node to each other in response to a second signal, a fourth transistor configured to connect the first node and the third node to each other in response to a third signal, a fifth transistor configured to transfer an initialization voltage to an anode of a light-emitting element in response to a fourth signal, a sixth transistor configured to connect the second node and the anode of the light-emitting element to each other in response to a fifth signal, and the light-emitting element including the anode, and a cathode configured to receive a second power supply voltage.

In one or more embodiments, in an initialization period, the initialization voltage may be applied to the anode of the light-emitting element through the fifth transistor, the initialization voltage may be applied to the first node through the fifth transistor, the sixth transistor, and the third transistor, and the initialization voltage may be applied to the third node through the fifth transistor, the sixth transistor, the third transistor, and the fourth transistor.

In one or more embodiments, in a threshold voltage compensation period, the third transistor may be configured to diode-connect the first transistor, and the first capacitor may store a threshold voltage of the first transistor.

In one or more embodiments, in the threshold voltage compensation period, the fourth transistor may connect the first node and the third node to each other, and the third node may have a voltage equal to a voltage of the first node.

In one or more embodiments, in a data writing period, the second transistor may be configured to apply the data voltage to the third node, the data voltage applied to the third node may be divided by the first capacitor and the second capacitor, and the divided data voltage may be transferred to the first node.

In one or more embodiments, an absolute value of the divided data voltage transferred to the first node may be less than an absolute value of the data voltage applied to the third node.

In one or more embodiments, the divided data voltage may be determined based on a capacitance of the first capacitor, a capacitance of the second capacitor, and the data voltage.

In one or more embodiments, a type of the first, second, third, fourth and sixth transistors may be different from a type of the fifth transistor.

In one or more embodiments, the first, second, third, fourth and sixth transistors may be P-type metal-oxide-semiconductor transistors, and the fifth transistor may be an N-type metal-oxide-semiconductor transistor.

In one or more embodiments, the first signal may be a write signal, the second signal and the third signal may be a same compensation signal, the fourth signal may be an initialization signal, and the fifth signal may be an emission signal.

In one or more embodiments, the second transistor may include a gate configured to receive the write signal, a first terminal connected to a data line, and a second terminal connected to the third node, the third transistor may include a gate configured to receive the compensation signal, a first terminal connected to the second node, and a second terminal connected to the first node, the fourth transistor may include a gate configured to receive the compensation signal, a first terminal connected to the first node, and a second terminal connected to the third node, the fifth transistor may include a gate configured to receive the initialization signal, a first terminal configured to receive the initialization voltage, and a second terminal connected to the anode of the light-emitting element, and the sixth transistor may include a gate configured to receive the emission signal, a first terminal connected to the second node, and a second terminal connected to the anode of the light-emitting element.

In one or more embodiments, a frame period for the display device may include an initialization period in which the anode of the light-emitting element, the first node, and the third node are initialized, a threshold voltage compensation period in which a threshold voltage of the first transistor is stored in the first capacitor, a data writing period in which the data voltage is provided through a data line, and an emission period in which the light-emitting element is configured to emit light.

In one or more embodiments, in the initialization period, the initialization signal and the write signal may have a high level, the emission signal and the compensation signal may have a low level, the third and fourth transistors may be turned on in response to the compensation signal having the low level, the fifth transistor may be turned on in response to the initialization signal having the high level, the sixth transistor may be turned on in response to the emission signal having the low level, the anode of the light-emitting element may be initialized based on the initialization voltage transferred through the fifth transistor, the first node may be initialized based on the initialization voltage transferred through the fifth transistor, the sixth transistor, and the third transistor, and the third node may be initialized based on the initialization voltage transferred through the fifth transistor, the sixth transistor, the third transistor and the fourth transistor.

In one or more embodiments, in the threshold voltage compensation period, the emission signal, the initialization signal and the write signal may have a high level, the compensation signal may have a low level, the third and fourth transistors may be turned on in response to the compensation signal having the low level, the fifth transistor may be turned on in response to the initialization signal having the high level, the third transistor may be configured to diode-connect the first transistor such that the threshold voltage of the first transistor is stored in the first capacitor, the fourth transistor may connect the first node and the third node to each other such that the third node has a voltage equal to a voltage of the first node, and the fifth transistor may be configured to apply the initialization voltage to the anode of the light-emitting element.

In one or more embodiments, in the data writing period, the emission signal, the initialization signal and the compensation signal may have a high level, the write signal may have a low level, the second transistor may be turned on in response to the write signal having the low level, the fifth transistor may be turned on in response to the initialization signal having the high level, the second transistor may be configured to apply the data voltage to the third node, the data voltage applied to the third node may be divided by the first capacitor and the second capacitor such that the divided data voltage is transferred to the first node, and the fifth transistor may be configured to apply the initialization voltage to the anode of the light-emitting element.

In one or more embodiments, in the emission period, the compensation signal and the write signal may have a high level, the emission signal and the initialization signal may have a low level, the sixth transistor may be turned on in response to the emission signal having the low level, the first transistor may be configured to generate a driving current based on a voltage of the first node, the sixth transistor may be configured to transfer the driving current generated by the first transistor to the light-emitting element, and the light-emitting element may be configured to emit light based on the driving current.

In one or more embodiments, the first signal may be a write signal, the second signal may be a compensation signal, the third signal may be a reference signal that is different from the compensation signal, the fourth signal may be an initialization signal, and the fifth signal may be an emission signal.

In one or more embodiments, the pixel may further include a seventh transistor connected between the second node and the sixth transistor, and configured to operate as an active load in response to a direct-current (DC) voltage.

In one or more embodiments, the seventh transistor may include a gate configured to receive the DC voltage, a first terminal connected to the second node, and a second terminal connected to the sixth transistor.

In one or more embodiments, the pixel may further include an eighth transistor that is diode-connected between a line that is configured to transfer the first power supply voltage and the first terminal of the first transistor.

According to one or more embodiments, there is provided a display device including a display panel including a plurality of pixels, a data driver configured to provide a data voltage to each of the plurality of pixels, a scan driver configured to provide a write signal, a compensation signal and an initialization signal to each of the plurality of pixels, an emission driver configured to provide an emission signal to each of the plurality of pixels, and a controller configured to control the data driver, the scan driver and the emission driver. Each of the plurality of pixels includes a first transistor including a gate connected to a first node, a first terminal configured to receive a first power supply voltage, and a second terminal connected to a second node, a first capacitor including a first electrode configured to receive the first power supply voltage, and a second electrode connected to the first node, a second capacitor including a first electrode connected to a third node, and a second electrode connected to the first node, a second transistor configured to transfer the data voltage to the third node in response to the write signal, a third transistor configured to connect the first node and the second node to each other in response to the compensation signal, a fourth transistor configured to connect the first node and the third node to each other in response to the compensation signal, a fifth transistor configured to transfer an initialization voltage to an anode of a light-emitting element in response to the initialization signal, a sixth transistor configured to connect the second node and the anode of the light-emitting element to each other in response to the emission signal, and the light-emitting element including the anode, and a cathode configured to receive a second power supply voltage.

According to one or more embodiments, there is provided an electronic device including a processor configured to provide input image data, and a display device including a plurality of pixels, and configured to drive the plurality of pixels based on the input image data. Each of the plurality of pixels includes a first transistor including a gate connected to a first node, a first terminal configured to receive a first power supply voltage, and a second terminal connected to a second node, a first capacitor including a first electrode configured to receive the first power supply voltage, and a second electrode connected to the first node, a second capacitor including a first electrode connected to a third node, and a second electrode connected to the first node, a second transistor configured to transfer a data voltage to the third node in response to a first signal, a third transistor configured to connect the first node and the second node to each other in response to a second signal, a fourth transistor configured to connect the first node and the third node to each other in response to a third signal, a fifth transistor configured to transfer an initialization voltage to an anode of a light-emitting element in response to a fourth signal, a sixth transistor configured to connect the second node and the anode of the light-emitting element to each other in response to a fifth signal, and the light-emitting element including the anode, and a cathode configured to receive a second power supply voltage.

In one or more embodiments, in an initialization period, the initialization voltage may be applied to the anode of the light-emitting element through the fifth transistor, the initialization voltage may be applied to the first node through the fifth transistor, the sixth transistor, and the third transistor, and the initialization voltage may be applied to the third node through the fifth transistor, the sixth transistor, the third transistor, and the fourth transistor.

In one or more embodiments, in a threshold voltage compensation period, the third transistor may be configured to diode-connect the first transistor, and the first capacitor may store a threshold voltage of the first transistor.

In one or more embodiments, in a data writing period, the second transistor may apply the data voltage to the third node, the data voltage applied to the third node may be divided by the first capacitor and the second capacitor, and the divided data voltage may be transferred to the first node.

In one or more embodiments, an absolute value of the divided data voltage transferred to the first node may be less than an absolute value of the data voltage applied to the third node.

In one or more embodiments, the divided data voltage may be determined based on a capacitance of the first capacitor, a capacitance of the second capacitor, and the data voltage.

As described above, in a pixel, a display device and an electronic device according to one or more embodiments, the pixel may include a small number of transistors and may have a small size.

Further, in the pixel, the display device and the electronic device according to one or more embodiments, a data voltage applied to the pixel may be divided by two capacitors when the data voltage is transferred to a first node (e.g., a gate node). Accordingly, a data voltage range for the pixel may be increased.

In addition, in the pixel, the display device and the electronic device according to one or more embodiments, the first node, a second node and a third node of the pixel may be substantially concurrently (e.g., simultaneously) initialized based on an initialization voltage.

### BRIEF DESCRIPTION OF THE DRAWINGS

Illustrative, non-limiting embodiments will be more clearly understood from the following detailed description in conjunction with the accompanying drawings.

FIG. 1 is a circuit diagram illustrating a pixel according to one or more embodiments.

FIG. 2 is a timing diagram for describing an operation of a pixel according to one or more embodiments.

FIG. 3 is a circuit diagram for describing an example of an operation of a pixel in an initialization period.

FIG. 4 is a circuit diagram for describing an example of an operation of a pixel in a threshold voltage compensation period.

FIG. 5 is a circuit diagram for describing an example of an operation of a pixel in a data writing period.

FIG. 6 is a circuit diagram for describing an example of an operation of a pixel in an emission period.

FIG. 7 is a timing diagram for describing an operation of a pixel according to one or more embodiments.

FIG. 8 is a circuit diagram illustrating a pixel according to one or more embodiments.

FIG. 9 is a circuit diagram illustrating a pixel according to embodiments.

FIG. 10 is a circuit diagram illustrating a pixel according to one or more embodiments.

FIG. 11 is a diagram illustrating an example of a driving current according to a source-drain voltage of a driving transistor in a pixel according to one or more embodiments.

FIG. 12 is a circuit diagram illustrating a pixel according to one or more embodiments.

FIG. 13 is a diagram illustrating an example of a driving current according to a source-drain voltage of a driving transistor in a pixel according to one or more embodiments.

FIG. 14 is a block diagram illustrating a display device according to one or more embodiments.

FIG. 15 is a block diagram illustrating an electronic device including a display device according to one or more embodiments.

FIG. 16 is a block diagram illustrating an example of an electronic device according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, embodiments are merely described below, by referring to the figures, to explain aspects of the present disclosure. As used herein, the term “and/or” includes any and all combinations of one or more of the associated listed items. Throughout the present disclosure, the expression “at least one of a, b or c” indicates only a, only b, only c, both a and b, both a and c, both b and c, all of a, b, and c, or any variations thereof.

As various modifications may be applied and numerous embodiments may be implemented, particular embodiments will be illustrated in the drawings and described in detail in the written description. Effects, aspects, and features, and methods for achieving them will be clarified with reference to embodiments described below in detail with reference to the drawings. However, embodiments may have different forms and should not be construed as being limited to the descriptions set forth herein.

Hereinafter, embodiments will now be described in detail with reference to the accompanying drawings. When described with reference to the drawings, identical or corresponding elements will be given the same reference numerals, and redundant description of these elements will be omitted.

It will be understood that although the terms “first”, “second”, etc. may be used herein to describe various elements, these elements should not be limited by these terms. These elements are only used to distinguish one element from another.

As used herein, the singular forms include the plural forms unless the context clearly indicates otherwise.

Also, it will be understood that the terms “comprise,” “include,” and “have” used herein specify the presence of stated features or elements, but do not preclude the presence or addition of one or more other features or elements.

It will be understood that when a layer, a region, or an element is referred to as being “on,” another layer, region, or element, it may be directly on the other layer, region, or element, or intervening layers, regions, or elements may be present therebetween.

It will be understood that when a layer, region, or element is referred to as being “connected to” another layer, region, or element, it may be “directly connected to” the other layer, region, or element or may be “indirectly connected to” the other layer, region, or element with one or more intervening layers, regions, or elements therebetween. For example, it will be understood that when a layer, region, or element is referred to as being “electrically connected to” another layer, region, or element, it may be “directly electrically connected to” the other layer, region, or element and/or may be “indirectly electrically connected to” the other layer, region, or element with one or more intervening layers, regions, or elements therebetween.

In the present specification, the expression “A and/or B” indicates A, B, or A and B. In addition, the expression such as “at least one of A and B” may include A, B, or A and B.

In the present specification, the x-axis, the y-axis, and the z-axis are not limited to directions according to three axes of the rectangular coordinate system, and may be interpreted in a broader sense. For example, the x-axis, the y-axis, and the z-axis may be orthogonal to each other, but may refer to different directions that are not orthogonal to each other.

In the present specification, the term “plane” refers to when a target portion is viewed from above (e.g., when viewed in a direction perpendicular to the upper surface of a substrate), and the term “cross-sectional” refers to when a vertically cut cross-section of the target portion is viewed from the side.

In the present specification, when a first element overlaps a second element, it may mean that the first element is arranged over or below the second element and at least partially overlaps the second element in a plane.

In the present specification, when a certain embodiment may be implemented differently, a specific process order may also be performed differently from the described order. As an example, two processes that are successively described may be performed substantially concurrently (e.g., simultaneously) or performed in an order opposite to the order described.

Sizes of elements in the drawings may be exaggerated for convenience of description. For example, because sizes and thicknesses of elements in the drawings are arbitrarily illustrated for convenience of explanation, the following embodiments are not limited thereto.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Hereinafter, embodiments of the present disclosure will be explained in detail with reference to the accompanying drawings. The same reference numerals are used for the same components in the drawings, and duplicate descriptions of the same components are omitted.

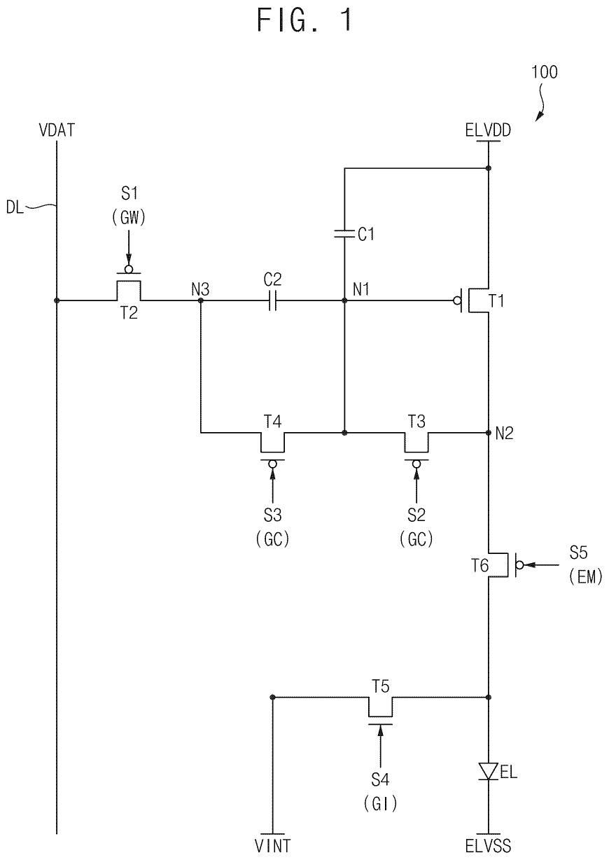

FIG. 1 is a circuit diagram illustrating a pixel according to one or more embodiments.

Referring to FIG. 1, a pixel 100 according to one or more embodiments may include a first transistor T1, a first capacitor C1, a second capacitor C2, a second transistor T2, a third transistor T3, a fourth transistor T4, a fifth transistor T5, a sixth transistor T6 and a light-emitting element EL.

The first transistor T1 may generate a driving current based on a voltage of a first node N1. Here, the first node N1 may be a gate node connected to a gate of the first transistor T1. The first transistor T1 may be referred to as a driving transistor for generating the driving current provided to the light-emitting element EL. In one or more embodiments, the first transistor T1 may include the gate connected to the first node N1, a first terminal (e.g., a source) that receives a first power supply voltage ELVDD (e.g., a high power supply voltage), and a second terminal (e.g., a drain) connected to a second node N2. Here, a first component being “connected” to a second component may include the first component being directly connected to the second component without an intermediate component between the first component and the second component, and the first component being indirectly connected to the second component via an intermediate component.

The first capacitor C1 may be connected between a line that transfers the first power supply voltage ELVDD and the first node N1. In one or more embodiments, the first capacitor C1 may include a first electrode connected to the line that transfers the first power supply voltage ELVDD, and a second electrode connected to the first node N1.

The second capacitor C2 may be connected between a third node N3 and the first node N1. In one or more embodiments, the second capacitor C2 may include a first electrode connected to the third node N3, and a second electrode connected to the first node N1.

The second transistor T2 may transfer a data voltage VDAT from a data line DL to the third node N3 in response to a first signal S1. The second transistor T2 may be referred to as a scan transistor or a switching transistor for transferring a voltage from the data line DL to the third node N3. In one or more embodiments, the first signal S1 may be a write signal GW. Further, in one or more embodiments, the second transistor T2 may include a gate that receives the write signal GW, a first terminal connected to the data line DL, and a second terminal connected to the third node N3.

The third transistor T3 may connect the first node N1 and the second node N2 to each other in response to a second signal S2. Thus, the third transistor T3 may diode-connect the first transistor T1 in response to the second signal S2. The third transistor T3 may be referred to as a compensation transistor for storing a threshold voltage of the first transistor T1 in the first capacitor C1. In one or more embodiments, the second signal S2 may be a compensation signal GC. Further, in one or more embodiments, the third transistor T3 may include a gate that receives the compensation signal GC, a first terminal connected to the second node N2, and a second terminal connected to the first node N1.

The fourth transistor T4 may connect the first node N1 and the third node N3 to each other in response to a third signal S3. In one or more embodiments, as illustrated in FIG. 1, the second signal S2 and the third signal S3 may be a same compensation signal GC. Further, in one or more embodiments, the fourth transistor T4 may include a gate that receives the compensation signal GC, a first terminal connected to the first node N1, and a second terminal connected to the third node N3.

The fifth transistor T5 may transfer an initialization voltage VINT to an anode of the light-emitting element EL in response to a fourth signal S4. The fifth transistor T5 may be referred to as an initialization transistor or an anode initialization transistor for initializing the anode of the light-emitting element EL. In one or more embodiments, the fourth signal S4 may be an initialization signal GI. Further, in one or more embodiments, the fifth transistor T5 may include a gate that receives the initialization signal GI, a first terminal that receives the initialization voltage VINT, and a second terminal connected to the anode of the light-emitting element EL.

The sixth transistor T6 may connect the second node N2 and the anode of the light-emitting element EL to each other in response to a fifth signal S5. The sixth transistor T6 may be referred to as an emission transistor for forming a path for the driving current provided to the light-emitting element EL. In one or more embodiments, the fifth signal S5 may be an emission signal EM. Further, in one or more embodiments, the sixth transistor T6 may include a gate that receives the emission signal EM, a first terminal connected to the second node N2, and a second terminal connected to the anode of the light-emitting element EL.

The light-emitting element EL may emit light based on the driving current generated by the first transistor T1. In one or more embodiments, the light-emitting element EL may be, but is not limited to, a micro light-emitting diode or an organic light-emitting diode (“OLED”). In one or more other embodiments, the light-emitting element EL may be a nano light-emitting diode (“NED”), a quantum dot (“QD”) light-emitting diode, an inorganic light-emitting diode, or any other suitable light-emitting element. Further, in one or more embodiments, the light-emitting element EL may include the anode connected to the fifth and sixth transistors T5 and T6, and a cathode connected to a line that transfers a second power supply voltage ELVSS (e.g., a low power supply voltage).

In one or more embodiments, a type of the first, second, third, fourth, and sixth transistors T1, T2, T3, T4, and T6 may be different from a type of the fifth transistor T5. For example, as illustrated in FIG. 1, the first, second, third, fourth, and sixth transistors T1, T2, T3, T4, and T6 may be P-type metal-oxide-semiconductor (“PMOS”) transistors, and the fifth transistor T5 may be an N-type metal-oxide-semiconductor (“NMOS”) transistor.

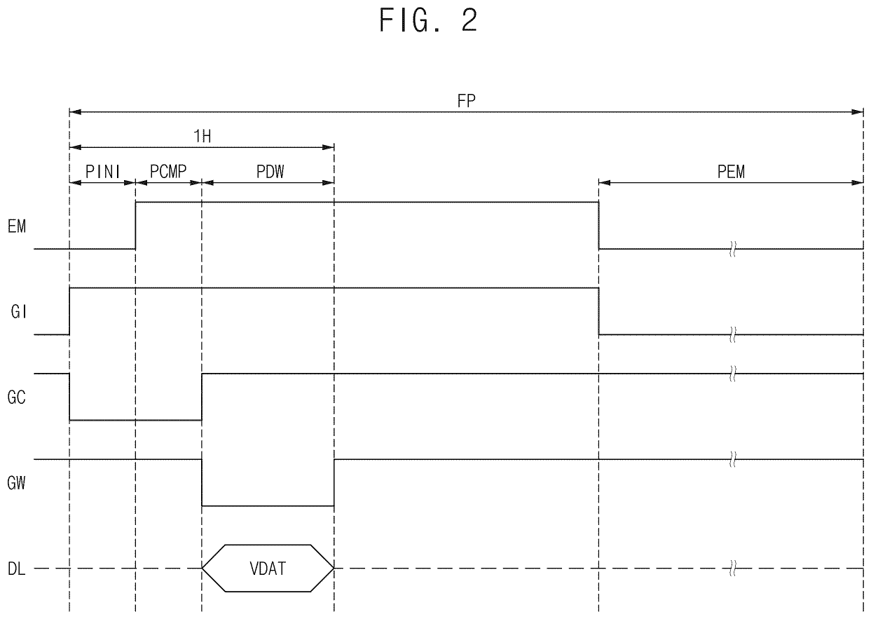

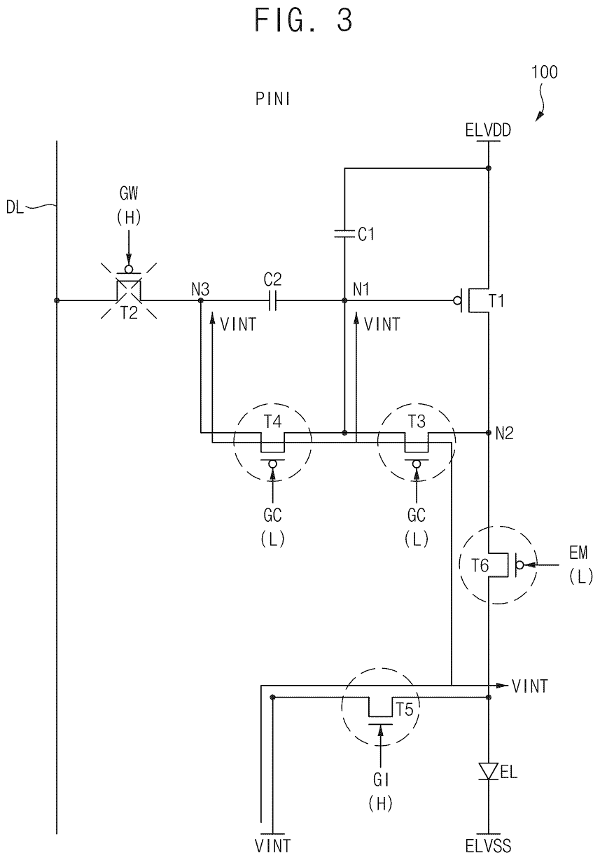

In the pixel 100 according to one or more embodiments, the anode of the light-emitting element EL, the first node N1, and the third node N3 may be substantially concurrently (e.g., simultaneously) initialized based on the initialization voltage VINT. For example, as described below with reference to FIGS. 2 and 3, in an initialization period PINI, the initialization voltage VINT may be applied to the anode of the light-emitting element EL through the fifth transistor T5, the initialization voltage VINT may be further applied to the first node N1 through the fifth transistor T5, the sixth transistor T6, and the third transistor T3, and the initialization voltage VINT may be further applied to the third node N3 through the fifth transistor T5, the sixth transistor T6, the third transistor T3, and the fourth transistor T4. Thus, the anode of the light-emitting element EL, the first node N1, and the third node N3 may be initialized based on the initialization voltage VINT.

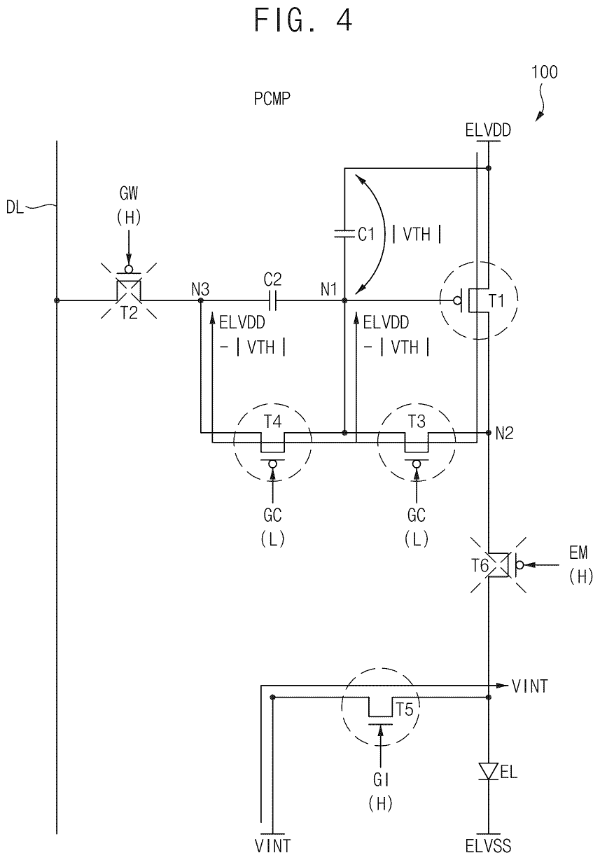

Further, in the pixel 100 according to one or more embodiments, a threshold voltage compensation operation for the first transistor T1 may be performed in a diode connection method. For example, as described below with reference to FIGS. 2 and 4, in a threshold voltage compensation period PCMP, the third transistor T3 may diode-connect the first transistor T1, and the first capacitor C1 may store a threshold voltage (or an absolute value |VTH| of the threshold voltage) of the first transistor T1. Further, in the threshold voltage compensation period PCMP, the fourth transistor T4 may connect the first node N1 and the third node N3 to each other, and the third node N3 may have a voltage ELVDD-|VTH| substantially the same as the voltage of the first node N1, or a voltage ELVDD-|VTH| obtained by subtracting the absolute value |VTH| of the threshold voltage of the first transistor T1 from the first power supply voltage ELVDD.

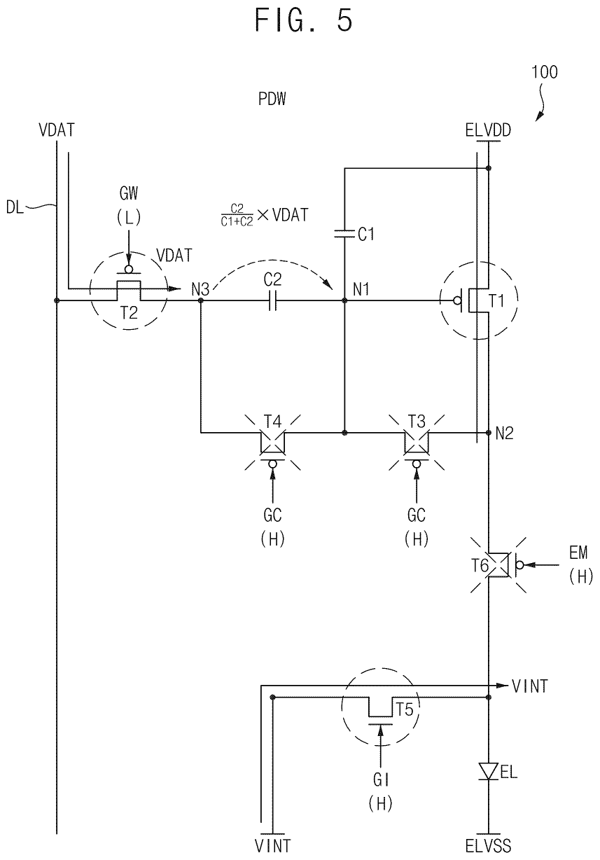

In addition, in the pixel 100 according to one or more embodiments, the data voltage VDAT may be divided (or distributed) by the first and second capacitors C1 and C2 to generate a divided data voltage, and the divided data voltage may be transferred to the first node N1 (or the gate node). For example, as described below with reference to FIGS. 2 and 5, in a data writing period PDW, the second transistor T2 may apply the data voltage VDAT to the third node N3, the data voltage VDAT applied to the third node N3 may be transferred to the first node N1 by a coupling of the second capacitor C2, and the data voltage transferred to the first node N1 (or the gate node) may be the data voltage divided (or distributed) by the first capacitor C1 and the second capacitor C2. In one or more embodiments, the divided data voltage transferred to the first node N1 may be determined by an equation “C2/(C1+C2)×VDAT”, where C1 is a capacitance of the first capacitor C1, C2 is a capacitance of the second capacitor C2, and VDAT is the data voltage VDAT applied to the third node N3. Thus, because the data voltage VDAT applied to the pixel 100 is divided (or distributed) by the first capacitor C1 and the second capacitor C2, and the divided data voltage is applied to the first node N1 (i.e., the gate node), an absolute value of the divided data voltage applied to the first node N1 and the gate of the first transistor T1 may be less than an absolute value of the data voltage VDAT applied to the third node N3. That is, the absolute value of the data voltage VDAT may be greater than the absolute value of the divided data voltage applied to the gate of the first transistor T1, and a range of the data voltage VDAT may be increased (e.g., may be greater) compared with (e.g., in comparison to) a range of the divided data voltage applied to the gate of the first transistor T1. Thus, in a display device including the pixel 100, a data voltage range from the data voltage VDAT corresponding to a minimum gray level (e.g., a 0-gray level) to the data voltage VDAT corresponding to a maximum gray level (e.g., a 255-gray level) may be increased, and an image may be displayed with accurate luminances corresponding to respective gray levels. Further, because the data voltage range for the pixel 100 is increased, the pixel 100 according to one or more embodiments may be suitable for an OLED on silicon (“OLEDoS”) display device in which the pixel 100 is formed on a flexible semiconductor substrate.

Hereinafter, an operation of the pixel 100 according to one or more embodiments is described below with reference to FIG. 1 -7.

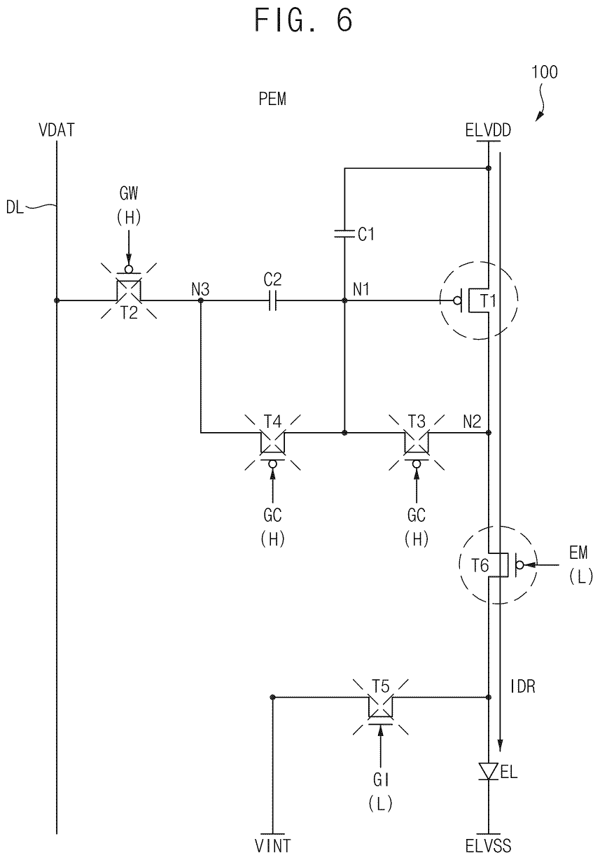

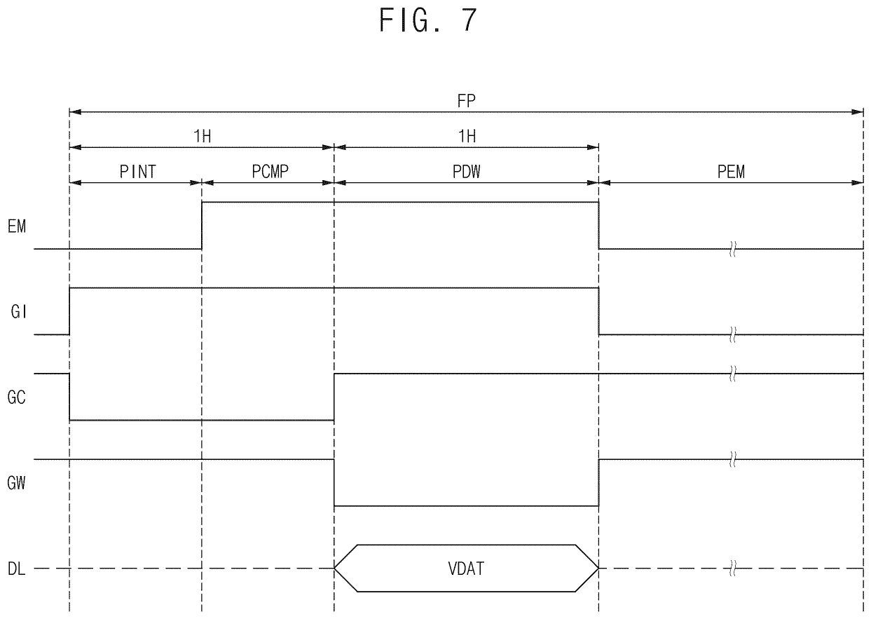

FIG. 2 is a timing diagram for describing an operation of a pixel according to one or more embodiments, FIG. 3 is a circuit diagram for describing an example of an operation of a pixel in an initialization period, FIG. 4 is a circuit diagram for describing an example of an operation of a pixel in a threshold voltage compensation period, FIG. 5 is a circuit diagram for describing an example of an operation of a pixel in a data writing period, FIG. 6 is a circuit diagram for describing an example of an operation of a pixel in an emission period, and FIG. 7 is a timing diagram for describing an operation of a pixel according to one or more embodiments.

Referring to FIGS. 1 and 2, a frame period FP for the display device including the pixel 100 may include an initialization period PINI in which the anode of the light-emitting element EL, the first node N1 and the third node N3 are initialized, a threshold voltage compensation period PCMP in which a threshold voltage (or an absolute value of the threshold voltage) of the first transistor T1 is stored in the first capacitor C1, a data writing period PDW in which the data voltage VDAT is provided through the data line DL, and an emission period PEM in which the light-emitting element EL emits light.

In the initialization period PINI, as illustrated in FIGS. 2 and 3, the initialization signal GI and the write signal GW may have a high level H, and the emission signal EM and the compensation signal GC may have a low level L. Here, the high level H may be a voltage level higher than the low level L, and may be a voltage level capable of turning on an NMOS transistor (e.g., the fifth transistor T5) and turning off a PMOS transistor (e.g., the second, third, fourth, and sixth transistors T2, T3, T4 and T6). Further, here, the low level L may be a voltage level lower than the high level H, and may be a voltage level capable of turning on the PMOS transistor and turning off the NMOS transistor. The third and fourth transistors T3 and T4 may be turned on in response to the compensation signal GC having the low level L, the fifth transistor T5 may be turned on in response to the initialization signal GI having the high level H, and the sixth transistor T6 may be turned on in response to the emission signal EM having the low level L. Further, the second transistor T2 may be turned off in response to the write signal GW having the high level H. Thus, the anode of the light-emitting element EL may be initialized based on the initialization voltage VINT transferred through the fifth transistor T5, the first node N1 may be initialized based on the initialization voltage VINT transferred through the fifth transistor T5, the sixth transistor T6, and the third transistor T3, and the third node N3 may be initialized based on the initialization voltage VINT transferred through the fifth transistor T5, the sixth transistor T6, the third transistor T3, and the fourth transistor T4. Accordingly, in the pixel 100 according to one or more embodiments, the anode of the light-emitting element EL, the first node N1, and the third node N3 may be substantially concurrently (e.g., simultaneously) initialized based on the initialization voltage VINT in the initialization period PINI.

In one or more embodiments, the fifth transistor T5 may be an NMOS transistor that is turned on in response to the initialization signal GI having the high level H. Further, for example, the initialization voltage VINT may be about 0 V, and the initialization signal GI may have about 5 V in the initialization period PINI. In this case, in the initialization period PINI, the fifth transistor T5 may have a gate-source voltage of about 5 V, and may apply the initialization voltage VINT of about 0 V to the anode of the light-emitting element EL. In a case where the fifth transistor T5 is a PMOS transistor, the initialization voltage VINT plus an absolute value of a threshold voltage of the PMOS transistor may be applied to the anode of the light-emitting element EL. However, in the pixel 100 according to one or more embodiments, the fifth transistor T5 that is the NMOS transistor may apply the initialization voltage VINT of about 0 V to the anode of the light-emitting element EL, and the anode of the light-emitting element EL may be sufficiently or stably initialized.

In the threshold voltage compensation period PCMP after the initialization period PINI, as illustrated in FIGS. 2 and 4, the emission signal EM, the initialization signal GI, and the write signal GW may have the high level H, and the compensation signal GC may have the low level L. The third and fourth transistors T3 and T4 may be turned on in response to the compensation signal GC having the low level L. The third transistor T3 may diode-connect the first transistor T1 by connecting the first node N1 and the second node N2 to each other. Thus, the voltage of the first node N1 may be a voltage ELVDD-|VTH| obtained by subtracting the absolute value |VTH| of the threshold voltage of the first transistor T1 from the first power supply voltage ELVDD. Accordingly, because a voltage of the first electrode of the first capacitor C1 is the first power supply voltage ELVDD and a voltage of the second electrode of the first capacitor C1 is “ELVDD-|VTH|”, the first capacitor C1 may store the absolute value |VTH| of the threshold voltage of the first transistor T1 between the first and second electrodes. That is, in the pixel 100 according to one or more embodiments, a threshold voltage compensation operation for the first transistor T1 may be performed in a diode connection method.

Further, in the threshold voltage compensation period PCMP, the fourth transistor T4 may connect the first node N1 and the third node N3 to each other. Thus, the third node N3 may have a voltage substantially the same as the voltage of the first node N1, or the voltage ELVDD-|VTH| obtained by subtracting the absolute value |VTH| of the threshold voltage of the first transistor T1 from the first power supply voltage ELVDD. The fifth transistor T5 may be turned on in response to the initialization signal GI having the high level H, and may apply the initialization voltage VINT to the anode of the light-emitting element EL. Thus, the anode of the light-emitting element EL may be initialized based on the initialization voltage VINT. The second transistor T2 may be turned off in response to the write signal GW having the high level H, and the sixth transistor T6 may be turned off in response to the emission signal EM having the high level H.

In the data writing period PDW after the threshold voltage compensation period PCMP, as illustrated in FIGS. 2 and 5, the emission signal EM, the initialization signal GI, and the compensation signal GC may have the high level H, and the write signal GW may have the low level L. The second transistor T2 may be turned on in response to the write signal GW having the low level L, and the third and fourth transistors T3 and T4 may be turned off in response to the compensation signal GC having the high level H. The second transistor T2 may apply the data voltage VDAT from the data line DL to the third node N3. The data voltage VDAT applied to the third node N3 may be transferred to the first node N1 by a coupling of the second capacitor C2. Further, the data voltage transferred to the first node N1 (i.e., the gate node) may be the data voltage divided (or distributed) by the first capacitor C1 and the second capacitor C2. In one or more embodiments, the divided data voltage may be determined by an equation “C2/(C1+C2)×VDAT”, where C1 is a capacitance of the first capacitor C1, C2 is a capacitance of the second capacitor C2, and VDAT may be the data voltage applied to the third node N3. Thus, an absolute value of the data voltage VDAT applied to the third node N3 may be greater than an absolute value of the divided data voltage applied to the gate of the first transistor T1, and a range of the data voltage VDAT applied to the third node N3 may be increased compared to a range of the divided data voltage applied to the gate of the first transistor T1. Accordingly, in the display device including the pixel 100, a data voltage range from the data voltage VDAT corresponding to the minimum gray level (e.g., the 0-gray level) to the data voltage VDAT corresponding to the maximum gray level (e.g., the 255-gray level) may be increased, and an image may be displayed with accurate luminances corresponding to respective gray levels. As such, the pixel 100 may be suitable for an OLEDoS display device.

Further, in the data writing period PDW, the fifth transistor T5 may be turned on in response to the initialization signal GI having the high level H, and may apply the initialization voltage VINT to the anode of the light-emitting element EL. The anode of the light-emitting element EL may be initialized based on the initialization voltage VINT. The sixth transistor T6 may be turned off in response to the emission signal EM having the high level H.

In one or more embodiments, as illustrated in FIG. 2, a sum of time lengths of the initialization period PINI, the threshold voltage compensation period PCMP, and the data writing period PDW for a pixel row may correspond to one horizontal time 1H allocated to the pixel row. Here, one horizontal time 1H may be a time allocated to one pixel row, which may correspond to a time obtained by dividing the frame period FP by the number of pixel rows of the display device. In this case, in a next horizontal time subsequent to the data writing period PDW for the pixel row, the initialization signal GI, the compensation signal GC, and the write signal GW for a next pixel row may be applied to the next pixel row. In one or more other embodiments, as illustrated in FIG. 7, a sum of time lengths of the initialization period PINI and the threshold voltage compensation period PCMP for a pixel row may correspond to one horizontal time 1H allocated to the pixel row, and a time length of the data writing period PDW for the pixel row may correspond to a subsequent one horizontal time 1H. In this case, during the data writing period PDW for the pixel row, the initialization signal GI and the compensation signal GC for a next pixel row may be applied to the next pixel row. Further, in a next horizontal time subsequent to the data writing period PDW for the pixel row, the write signal GW for the next pixel row may be applied to the next pixel row.

In the emission period PEM after the data writing period PDW, as illustrated in FIGS. 2 and 6, the compensation signal GC and the write signal GW may have the high level H, and the emission signal EM and the initialization signal GI may have the low level L. The first transistor T1 may generate the driving current IDR based on the voltage of the first node N1. Further, the sixth transistor T6 may be turned on in response to the emission signal EM having the low level L, and may transfer the driving current IDR generated by the first transistor T1 to the light-emitting element EL. Thus, the light-emitting element EL may emit light based on the driving current IDR generated by the first transistor T1. Further, the second transistor T2 may be turned off in response to the write signal GW having the high level H, the third and fourth transistors T3 and T4 may be turned off in response to the compensation signal GC having the high level H, and the fifth transistor T5 may be turned off in response to the initialization signal GI having the low level L.

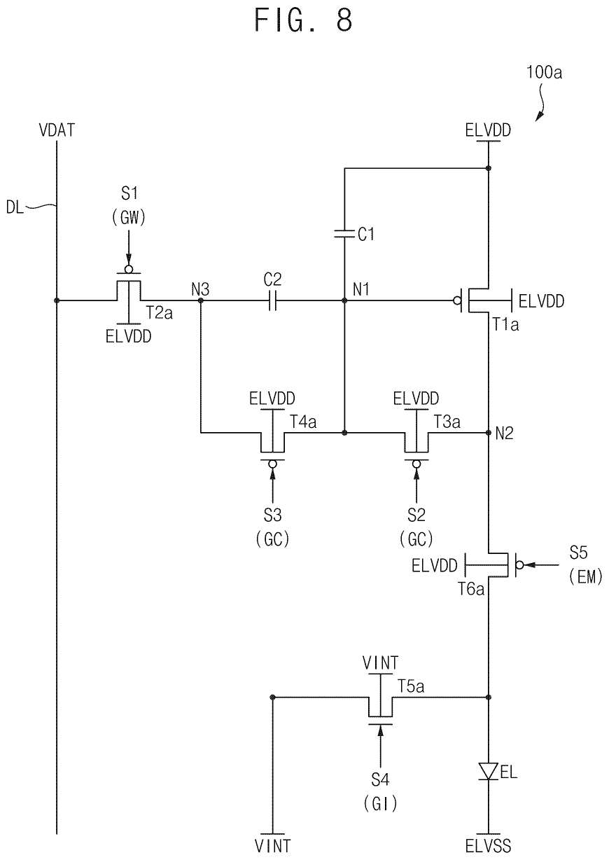

FIG. 8 is a circuit diagram illustrating a pixel according to one or more embodiments.

Referring to FIG. 8, a pixel 100a according to one or more embodiments may include a first transistor T1a, a first capacitor C1, a second capacitor C2, a second transistor T2a, a third transistor T3a, a fourth transistor T4a, a fifth transistor T5a, a sixth transistor T6a, and a light-emitting element EL. The pixel 100a of FIG. 8 may have substantially the same configuration and substantially the same operation as a pixel 100 of FIG. 1, except that a first power supply voltage ELVDD may be applied to bodies of the first, second, third, fourth, and sixth transistors T1a, T2a, T3a, T4a, and T6a, and an initialization voltage VINT may be applied to a body of the fifth transistor T5a.

In one or more embodiments, as illustrated in FIG. 8, the first, second, third, fourth, and sixth transistors T1, T2, T3, T4, and T6 may be implemented as PMOS transistors, and the fifth transistor T5 may be implemented as an NMOS transistor. Further, the first power supply voltage ELVDD may be applied to the bodies of the first, second, third, fourth, and sixth transistors T1, T2, T3, T4, and T6 that are the PMOS transistors, and the initialization voltage VINT may be applied to the body of the fifth transistor T5a that is the NMOS transistor.

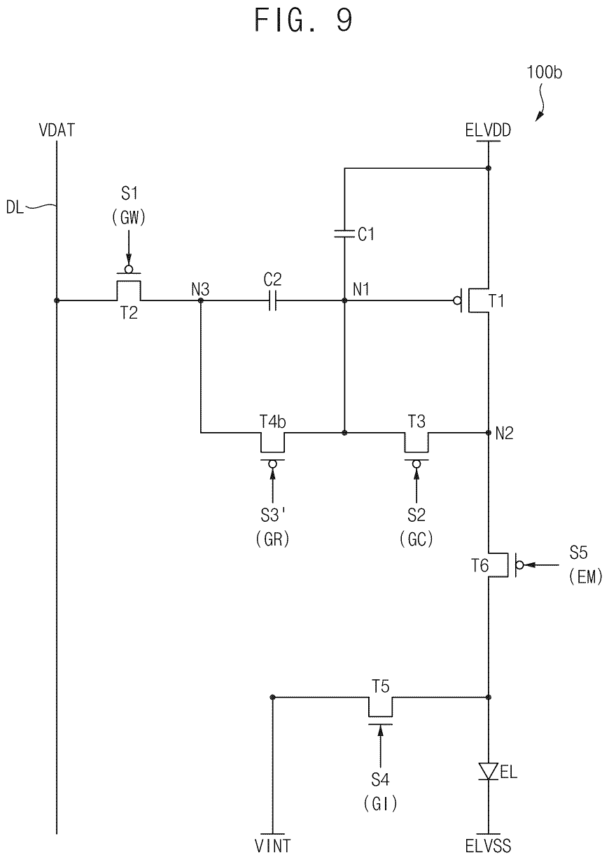

FIG. 9 is a circuit diagram illustrating a pixel according to one or more embodiments.

Referring to FIG. 9, a pixel 100b according to one or more embodiments may include a first transistor T1, a first capacitor C1, a second capacitor C2, a second transistor T2, a third transistor T3, a fourth transistor T4b, a fifth transistor T5, a sixth transistor T6, and a light-emitting element EL. The pixel 100b of FIG. 9 may have substantially the same configuration and substantially the same operation as a pixel 100 of FIG. 1, except that the fourth transistor T4b may receive a third signal S3′ different from a second signal S2 applied to the third transistor T3.

In one or more embodiments, the second signal S2 applied to the third transistor T3 may be a compensation signal GC, and the third signal S3′ applied to the fourth transistor T4b may be a reference signal GR different from the compensation signal GC. That is, in a display device including the pixel 100b, a scan driver that generates the reference signal GR may be different from a scan driver that generates the compensation signal GC, and a line that transfers the reference signal GR may be different from a line that transfers the compensation signal GC. Further, in one or more embodiments, the fourth transistor T4b may include a gate that receives the reference signal GR, a first terminal connected to a first node N1, and a second terminal connected to a third node N3.

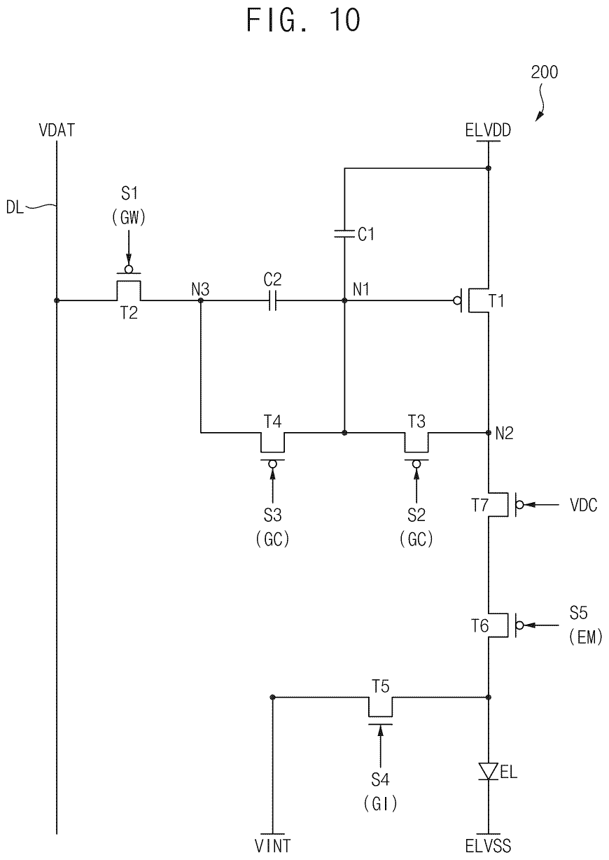

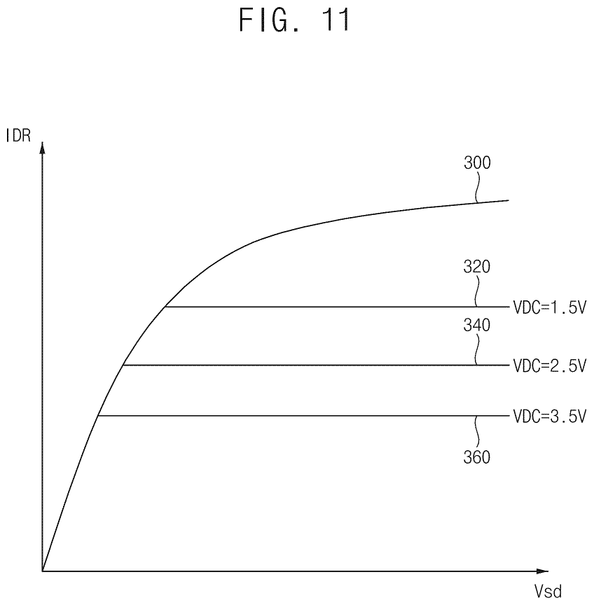

FIG. 10 is a circuit diagram illustrating a pixel according to one or more embodiments, and FIG. 11 is a diagram illustrating an example of a driving current according to a source-drain voltage of a driving transistor in a pixel according to one or more embodiments.

Referring to FIG. 10, a pixel 200 according to one or more embodiments may include a first transistor T1, a first capacitor C1, a second capacitor C2, a second transistor T2, a third transistor T3, a fourth transistor T4, a fifth transistor T5, a sixth transistor T6, a seventh transistor T7, and a light-emitting element EL. The pixel 200 of FIG. 10 may have substantially the same configuration and substantially the same operation as a pixel 100 of FIG. 1, except that the pixel 200 may further include the seventh transistor T7.

The seventh transistor T7 may be connected between a second node N2 and the sixth transistor T6, and may operate as an active load in response to a direct-current (“DC”) voltage VDC. In one or more embodiments, the seventh transistor T7 may include a gate that receives the DC voltage VDC, a first terminal connected to the second node N2, and a second terminal connected to the sixth transistor T6.

In one or more embodiments, the seventh transistor T7 may be implemented as a PMOS transistor, and a resistance (e.g., a turn-on resistance) of the seventh transistor T7 may increase as a voltage level of the DC voltage VDC increases. FIG. 11 illustrates a first curve 300 of a driving current IDR generated by the first transistor T1 according to a source-drain voltage Vsd of the first transistor T1 in a case where the pixel 200 does not include the seventh transistor T7, a second curve 320 of the driving current IDR according to the source-drain voltage Vsd in a case where the DC voltage VDC of about 1.5 V is applied to the seventh transistor T7, a third curve 340 of the driving current IDR according to the source-drain voltage Vsd in a case where the DC voltage VDC of about 2.5 V is applied to the seventh transistor T7, and a fourth curve 360 of the driving current IDR according to the source-drain voltage Vsd in a case where the DC voltage VDC of about 3.5 V is applied to the seventh transistor T7. For example, as illustrated in FIG. 11, in the case where the pixel 200 does not include the seventh transistor T7, as illustrated in the first curve 300, the driving current IDR generated by the first transistor T1 may not be substantially constant, and may increase as the source-drain voltage Vsd increases. However, in the cases where the pixel 200 includes the seventh transistor T7, as illustrated in the second, third, and fourth curves 320, 340, and 360, the first transistor T1 may generate the substantially constant driving current IDR when the source-drain voltage Vsd of the first transistor T1 is sufficiently high. Accordingly, in a display device including the pixel 200, a current deviation due to a voltage drop of the first power supply voltage ELVDD, a degradation (or deterioration) of the light-emitting element EL, etc. may be reduced. Further, as illustrated in the second, third, and fourth curves 320, 340, and 360, the driving current IDR may be adjusted by adjusting or controlling the voltage level of the DC voltage VDC. Accordingly, in the display device including the pixel 200, a range of a data voltage VDAT for generating the driving current IDR may be adjusted by adjusting the voltage level of the DC voltage VDC.

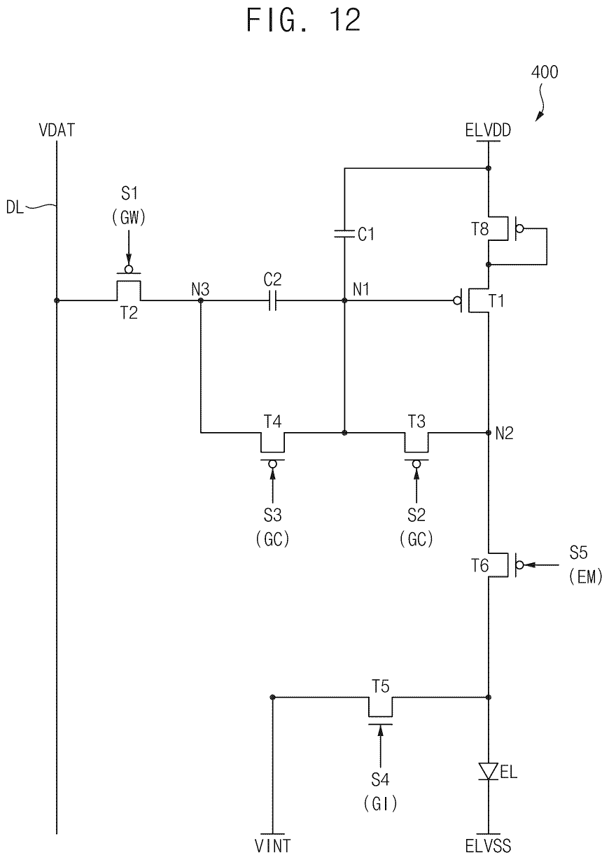

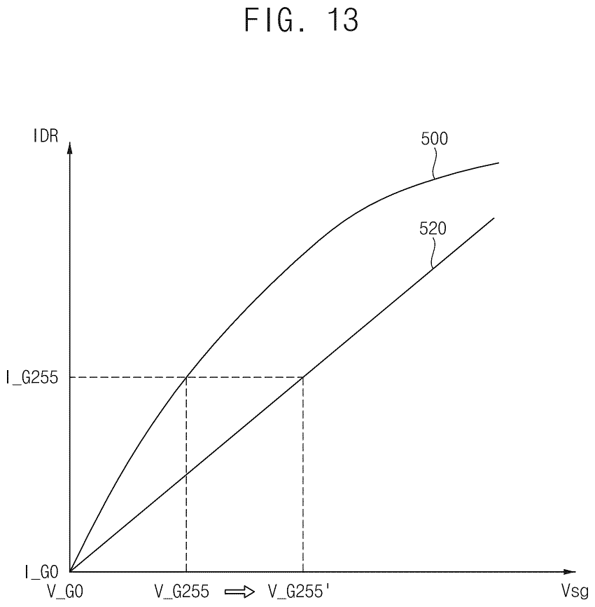

FIG. 12 is a circuit diagram illustrating a pixel according to one or more embodiments, and FIG. 13 is a diagram illustrating an example of a driving current according to a source-drain voltage of a driving transistor in a pixel according to one or more embodiments.

Referring to FIG. 12, a pixel 400 according to one or more embodiments may include a first transistor T1, a first capacitor C1, a second capacitor C2, a second transistor T2, a third transistor T3, a fourth transistor T4, a fifth transistor T5, a sixth transistor T6, an eighth transistor T8, and a light-emitting element EL. The pixel 400 of FIG. 12 may have substantially the same configuration and substantially the same operation as a pixel 100 of FIG. 1, except that the pixel 400 may further include the eighth transistor T8.

The eighth transistor T8 may be diode-connected between a line that transfers a first power supply voltage ELVDD and a first terminal (e.g., a source) of the first transistor T1. In one or more embodiments, the eighth transistor T8 may include a gate connected to the source of the first transistor T1, a first terminal (e.g., a source) connected to the line that transfers the first power supply voltage ELVDD, and a second terminal (e.g., a drain) connected to the source of the first transistor T1.

The eighth transistor T8 may perform a source degeneration operation, which is a negative feedback operation that decreases a source voltage of the first transistor T1 when the source voltage of the first transistor T1 increases. For example, if a driving current generated by the first transistor T1 increases and the source voltage of the first transistor T1 increases, a voltage applied to the gate of the eighth transistor T8 increases, and a source-drain current of the eighth transistor T8 may decrease. The source-drain current of the eighth transistor T8 may be the driving current generated by the first transistor T1. Thus, the driving current generated by the first transistor T1 may decrease, and the source voltage of the first transistor T1 may decrease. By this source degeneration operation of the eighth transistor T8, a linearity of the driving current generated by the first transistor T1 may be improved. FIG. 13 illustrates a first curve 500 of the driving current IDR generated by the first transistor T1 according to a source-gate voltage Vsg of the first transistor T1 in a case where the pixel 400 does not include the eighth transistor T8, and a second curve 520 of the driving current IDR generated by the second transistor T2 according to the source-gate voltage Vsg of the first transistor T1 in a case where the pixel 400 includes the eighth transistor T8. For example, as illustrated in the first and second curves 500 and 520 of FIG. 13, the linearity of the driving current IDR in the case the pixel 400 includes the eighth transistor T8 may be improved compared with the case where the pixel 400 does not include the eighth transistor T8. Further, the source-gate voltage V_G255′ of the first transistor T1 for generating a maximum driving current I_G255 corresponding to a maximum gray level (e.g., a 255-gray level) in the case where the pixel 400 includes the eighth transistor T8 may be increased from the source-gate voltage V_G255 of the first transistor T1 for generating the maximum driving current I_G255 in the case where the pixel 400 does not include the eighth transistor T8. That is, a voltage range from the source-gate voltage V_G0 corresponding to a minimum driving current I_G0 to the source-gate voltage V_G255′ corresponding to the maximum driving current I_G255 in the case where the pixel 400 includes the eighth transistor T8 may be increased compared with a voltage range from the source-gate voltage V_G0 corresponding to the minimum driving current I_G0 to the source-gate voltage V_G255 corresponding to the maximum driving current I_G255 in the case where the pixel 400 does not include the eighth transistor T8. Accordingly, a data voltage range for the pixel 400 including the eighth transistor T8 may be increased, and the pixel 400 may be suitable for an OLEDoS display device.

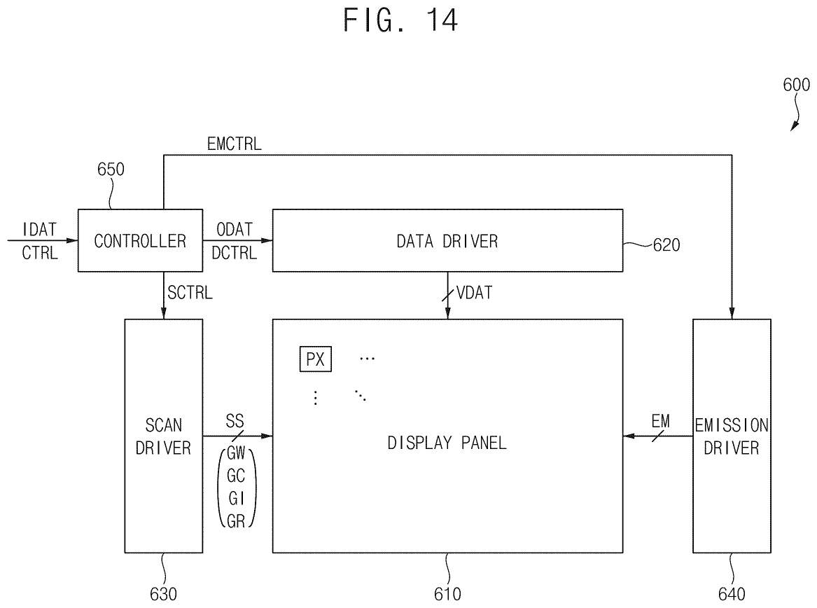

FIG. 14 is a block diagram illustrating a display device according to one or more embodiments.

Referring to FIG. 14, a display device 600 according to one or more embodiments may include a display panel 610 that includes a plurality of pixels PX, a data driver 620 that provides data voltages VDAT to the plurality of pixels PX, a scan driver 630 that provides scan signals SS to the plurality of pixels PX, an emission driver 640 that provides emission signals EM to the plurality of pixels PX, and a controller 650 that controls the data driver 620, the scan driver 630, and the emission driver 640.

The display panel 610 may include the plurality of pixels PX. According to one or more embodiments, each pixel PX of the display panel 610 may be a pixel 100 of FIG. 1, a pixel 100a of FIG. 8, a pixel 100b of FIG. 9, a pixel 200 of FIG. 10, a pixel 400 of FIG. 12, and/or the like. Each pixel PX may include a small number of transistors, and may be suitable for a high-resolution display device. Further, a data voltage VDAT applied to each pixel PX may be divided by two capacitors, and the divided data voltage may be transferred to a first node (e.g., a gate node). Accordingly, a range of the data voltage VDAT may be increased, and the pixel PX may be suitable for an OLEDoS display device.

The data driver 620 may generate the data voltages VDAT based on output image data ODAT and a data control signal DCTRL received from the controller 650, and may provide the data voltages VDAT to the plurality of pixels PX. In one or more embodiments, the data control signal DCTRL may include, but is not limited to, an output data enable signal, a horizontal start signal, and a load signal. Further, in one or more embodiments, the data driver 620 and the controller 650 may be implemented as a single integrated circuit (IC), and may be referred to as a timing controller embedded data driver (“TED”) integrated circuit (IC). In one or more other embodiments, the data driver 620 and the controller 650 may be implemented as separate integrated circuits (ICs).

The scan driver 630 may sequentially provide the scan signals SS to the plurality of pixels PX on a row-by-row basis based on a scan control signal SCTRL received from the controller 650. The scan control signal SCTRL may include, but is not limited to, a scan start signal and a scan clock signal. In one or more embodiments, the scan signals SS applied to each pixel PX may include, but are not limited to, a write signal GW, a compensation signal GC, an initialization signal GI and/or a reference signal GR. Further, in one or more embodiments, the scan driver 630 may be integrated or formed in the display panel 610. In one or more other embodiments, the scan driver 630 may be implemented with one or more integrated circuits (ICs).

The emission driver 640 may sequentially provide the emission signals EM to the plurality of pixels PX on a row-by-row basis based on an emission control signal EMCTRL received from the controller 650. The emission control signal EMCTRL may include, but is not limited to, an emission start signal and an emission clock signal. In one or more embodiments, the emission driver 640 may be integrated or formed in the display panel 610. In one or more other embodiments, the emission driver 640 may be implemented with one or more integrated circuits (ICs).

The controller 650 (e.g., a timing controller) may receive input image data IDAT and a control signal CTRL from an external processor (e.g., a graphics processing unit (“GPU”), an application processor (“AP”), and/or a graphics card). In one or more embodiments, the control signal CTRL may include, but is not limited to, a vertical synchronization signal, a horizontal synchronization signal, an input data enable signal, a master clock signal, etc. The controller 650 may generate the output image data ODAT, the data control signal DCTRL, the scan control signal SCTRL, and the emission control signal EMCTRL based on the input image data IDAT and the control signal CTRL. The controller 650 may control the data driver 620 by providing the output image data ODAT and the data control signal DCTRL to the data driver 620, may control the scan driver 630 by providing the scan control signal SCTRL to the scan driver 630, and may control the emission driver 640 by providing the emission control signal EMCTRL to the emission driver 640.

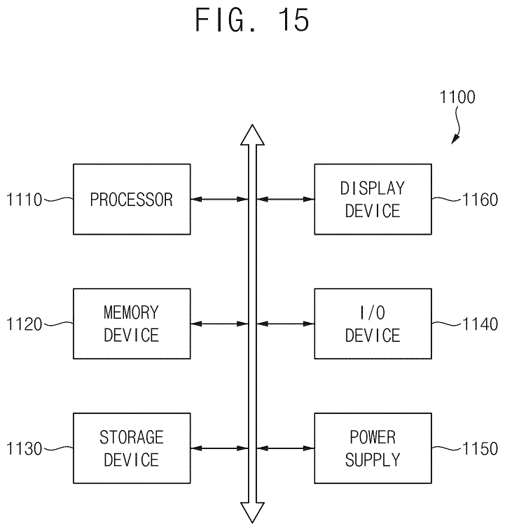

FIG. 15 is a block diagram illustrating an electronic device including a display device according to one or more embodiments.

Referring to FIG. 15, an electronic device 1100 may include a processor 1110, a memory device 1120, a storage device 1130, an input/output (I/O) device 1140, a power supply 1150, and a display device 1160. The electronic device 1100 may further include a plurality of ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. Further, in one or more embodiments, the processor 1110 may be further coupled to an extended bus such as a peripheral component interconnection (“PCI”) bus.

The memory device 1120 may store data for operations of the electronic device 1100. For example, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In the display device 1160, each pixel may include a small number of transistors and may have a small size. Further, a data voltage applied to each pixel may be divided (or distributed) by two capacitors when the data voltage is transferred to a first node (e.g., a gate node). Accordingly, a data voltage range for the pixel may be increased, and the pixel may be suitable for an OLEDoS display device.

Embodiments of the present disclosure may be applied to the electronic device 1100 including the display device 1160. For example, the embodiments of present disclosure may be applied to a virtual reality (“VR”) device, an augmented reality (“AR”) device, a mixed reality (“MR”) device, an extended reality (“XR”) device, a mobile phone, a smart phone, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

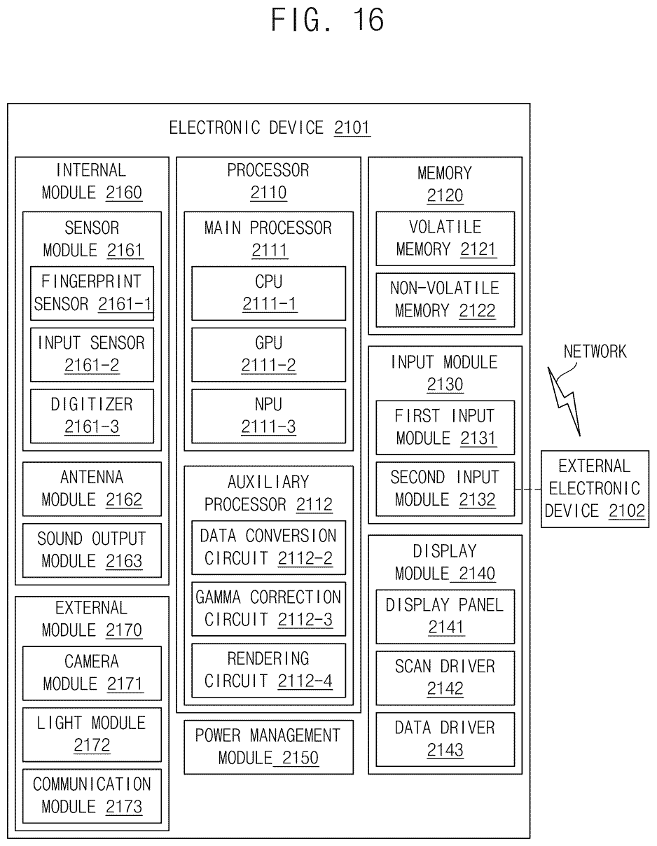

FIG. 16 is a block diagram illustrating an example of an electronic device according to one or more embodiments.

An electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

As another example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

As still another example, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component, or one component may be provided separately as two or more components.

Referring to FIG. 16, the electronic device 2101 may communicate with an external electronic device 2102 via a network (e.g., a short-range wireless communication network or a long-range wireless communication network). In one or more embodiments, the electronic device 2101 may include the processor 2110, the memory 2120, the input module 2130, the display module 2140, a power management module 2150, an internal module 2160, and an external module 2170. In one or more embodiments, at least one of the components may be omitted from the electronic device 2101, or one or more other components may be added in the electronic device 2101. In one or more embodiments, some of the components (e.g., the sensor module 2161, an antenna module 2162, and/or the sound output module 2163) may be implemented as a single component (e.g., the display module 2140).

The processor 2110 may execute software to control at least one other component (e.g., a hardware or software component) of the electronic device 2101 coupled with the processor 2110, and may perform various data processing or computation. According to one or more embodiments, as at least part of the data processing or computation, the processor 2110 may store a command or data received from another component (e.g., the input module 2130, the sensor module 2161, and/or a communication module 2173) in a volatile memory 2121, may process the command or the data stored in the volatile memory 2121, and may store resulting data in a non-volatile memory 2122.

The processor 2110 may include a main processor 2111 and an auxiliary processor 2112. The main processor 2111 may include one or more of a central processing unit (“CPU”) 2111-1 or an application processor (“AP”). The main processor 2111 may further include one or more of a graphics processing unit (“GPU”) 2111-2, a communication processor (“CP”), and/or an image signal processor (“ISP”). The main processor 2111 may further include a neural processing unit (“NPU”) 2111-3. The NPU 2111-3 may be a processor specialized in processing an artificial intelligence model, and the artificial intelligence model may be generated through machine learning. The artificial intelligence model may include a plurality of artificial neural network layers. The artificial neural network may be a deep neural network (“DNN”), a convolutional neural network (“CNN”), a recurrent neural network (“RNN”), a restricted Boltzmann machine (“RBM”), a deep belief network (“DBN”), a bidirectional recurrent deep neural network (“BRDNN”), deep Q-network or a combination of two or more thereof, but is not limited thereto. The artificial intelligence model may, additionally or alternatively, include a software structure other than a hardware structure. At least two of the above-described processing units and processors may be implemented as an integrated component (e.g., a single chip), or respective processing units and processors may be implemented as independent components (e.g., a plurality of chips).

The auxiliary processor 2112 may include a controller. The controller included in the auxiliary processor 2112 may correspond to a controller 650 illustrated in FIG. 14. The controller may include an interface conversion circuit and a timing control circuit. The controller may receive an image signal from the main processor 2111, may convert a data format of the image signal to meet interface specifications with the display module 2140, and may output image data. The controller may output various control signals required for driving the display module 2140.

The auxiliary processor 2112 may further include a data conversion circuit 2112-2, a gamma correction circuit 2112-3, a rendering circuit 2112-4, and/or the like. The data conversion circuit 2112-2 may receive image data from the controller. The data conversion circuit 2112-2 may compensate for the image data such that an image is displayed with a desired luminance according to characteristics of the electronic device 2101 or the user's setting, or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller, and may render the image data in consideration of a pixel arrangement of the display panel 2141 in the electronic device 2101. At least one of the data conversion circuit 2112-2, the gamma correction circuit 2112-3, or the rendering circuit 2112-4 may be integrated in another component (e.g., the main processor 2111 or the controller). At least one of the data conversion circuit 2112-2, the gamma correction circuit 2112-3, or the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 or the non-volatile memory 2122.

The input module 2130 may receive a command or data to be used by the components (e.g., the processor 2110, the sensor module 2161, and/or the sound output module 2163) of the electronic device 2101 from the outside of the electronic device 2101 (e.g., the user or the external electronic device 2102).

The input module 2130 may include a first input module 2131 for receiving a command or data from the user, and a second input module 2132 for receiving a command or data from the external electronic device 2102. The first input module 2131 may include a microphone, a mouse, a keyboard, a key (e.g., a button), and/or a pen (e.g., a passive pen or an active pen). The second input module 2132 may support a designated protocol capable of connecting the electronic device 2101 to the external electronic device 2102 by wire or wirelessly. In one or more embodiments, the second input module 2132 may include a high definition multimedia interface (“HDMI”), a universal serial bus (“USB”) interface, an SD card interface, and/or an audio interface. The second input module 2132 may include a connector that may physically connect the electronic device 2101 to the external electronic device 2102. For example, the second input module 2132 may include an HDMI connector, a USB connector, an SD card connector, and/or an audio connector (e.g., a headphone connector).

The display module 2140 may visually provide information to the user. The display module 2140 may include the display panel 2141, a scan driver 2142, and the data driver 2143. The display module 2140 may further include a window, a chassis, and a bracket for protecting the display panel 2141.

In the display panel 2141, each pixel may include a small number of transistors and may have a small size. Further, a data voltage applied to each pixel may be divided (or distributed) by two capacitors when the data voltage is transferred to a first node (e.g., a gate node). Accordingly, a data voltage range for the pixel may be increased, and the pixel may be suitable for an OLEDoS display device.

The display panel 2141 may include a liquid crystal display panel, an organic light-emitting display panel, or an inorganic light-emitting display panel, but the type of the display panel 2141 is not limited thereto. The display panel 2141 may be a rigid type display panel, or a flexible type display panel capable of being rolled and/or folded. The display module 2140 may further include a supporter, a bracket, and/or a heat dissipation member that supports the display panel 2141.

The scan driver 2142 may be mounted on the display panel 2141 as a driving chip. Alternatively, the scan driver 2142 may be integrated into the display panel 2141. For example, the scan driver 2142 may include an amorphous silicon TFT gate driver circuit (“ASG”), a low temperature polycrystalline silicon (“LTPS”) TFT gate driver circuit, and/or an oxide semiconductor TFT gate driver circuit (“OSG”) embedded in the display panel 2141. The scan driver 2142 may receive a control signal from the controller and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the scan driver 2142, or may be integrated into the scan driver 2142.

The data driver 2143 may receive a control signal from the controller, may convert image data into analog voltages (e.g., data voltages) in response to the control signal, and then may output the data voltages to the display panel 2141.

The data driver 2143 may be incorporated into other components (e.g., the controller). Further, the functions of the interface conversion circuit and the timing control circuit of the controller described above may be integrated into the data driver 2143.

The display module 2140 may further include a voltage generator circuit, and/or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell that is not rechargeable, a secondary cell that is rechargeable, and/or a fuel cell. The power management module 2150 may include a power management integrated circuit (“PMIC”). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162, and the sound output module 2163. The external module 2170 may include the camera module 2171, a light module 2172, and the communication module 2173.

The sensor module 2161 may detect an input by the user's body or an input by the pen of the first input module 2131, and may generate an electrical signal or data value corresponding to the input. The sensor module 2161 may include at least one of the fingerprint sensor 2161-1, the input sensor 2161-2, and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen, or may transfer/receive data to/from the active pen.

The input sensor 2161-2 may measure a bio-signal, such as blood pressure, moisture, and/or body fat. For example, when a portion of the body of the user touches a sensor layer or a sensing panel, and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen, or may transfer/receive data to/from the active pen.

At least one of the fingerprint sensor 2161-1, the input sensor 2161-2, and the digitizer 2161-3 may be implemented as a sensor layer formed on the display panel 2141 through a continuous process. The fingerprint sensor 2161-1, the input sensor 2161-2, and the digitizer 2161-3 may be disposed above the display panel 2141, or at least one of the fingerprint sensor 2161-1, the input sensor 2161-2, or the digitizer 2161-3 may be disposed below the display panel 2141.

Two or more of the fingerprint sensor 2161-1, the input sensor 2161-2, and the digitizer 2161-3 may be integrated into one sensing panel through the same process. When integrated into one sensing panel, the sensing panel may be disposed between the display panel 2141 and a window disposed above the display panel 2141. In one or more embodiments, the sensing panel may be disposed on the window, but the location of the sensing panel is not limited thereto.

At least one of the fingerprint sensor 2161-1, the input sensor 2161-2, or the digitizer 2161-3 may be embedded in the display panel 2141. In other words, at least one of the fingerprint sensor 2161-1, the input sensor 2161-2, or the digitizer 2161-2 may be concurrently (e.g., simultaneously) formed through a process of forming elements (e.g., light-emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (“IR”) sensor, a biometric sensor, a temperature sensor, a humidity sensor, and/or an illuminance sensor.

The antenna module 2162 may include one or more antennas for transmitting or receiving a signal or power to or from the outside. In one or more embodiments, the communication module 2173 may transfer or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker and/or a receiver. The speaker may be used for general purposes, such as playing multimedia or playing record. The receiver may be used for receiving incoming calls. In one or more embodiments, the receiver may be implemented as separate from, or as part of the speaker. A sound output pattern of the sound output module 2163 may be integrated into the display module 2140.

The camera module 2171 may capture a still image and/or a moving image. In one or more embodiments, the camera module 2171 may include one or more lenses, an image sensor, and/or an image signal processor. The camera module 2171 may further include an infrared camera capable of measuring the presence or absence of the user, the user's location, and/or the user's line of sight.

The light module 2172 may provide light. The light module 2172 may include a light-emitting diode and/or a xenon lamp. The light module 2172 may operate in conjunction with the camera module 2171, or may operate independently of the camera module 2171.

The communication module 2173 may support establishing a wired and/or wireless communication channel between the electronic device 2101 and the external electronic device 2102 and performing communication via the established communication channel. The communication module 2173 may include a wireless communication module (e.g., a cellular communication module, a short-range wireless communication module, and/or a global navigation satellite system (“GNSS”) communication module) or a wired communication module (e.g., a local area network (“LAN”) communication module and/or a power line communication (“PLC”) module). The communication module 2173 may communicate with the external electronic device 2102 via a short-range communication network (e.g., Bluetooth™, wireless-fidelity (“Wi-Fi”) direct, and/or infrared data association (“IrDA”)) and/or a long-range communication network (e.g., a cellular network, the Internet, and/or a computer network (e.g., LAN or wide area network (“WAN”))). These various types of communication modules 2173 may be implemented as a single chip, or may be implemented as multi-chips separate from each other.

The input module 2130, the sensor module 2161, the camera module 2171, and/or the like may be used to control an operation of the display module 2140 in conjunction with the processor 2110.

The processor 2110 may output a command or data to the display module 2140, the sound output module 2163, the camera module 2171, and/or the light module 2172 based on input data received from the input module 2130. For example, the processor 2110 may generate image data corresponding to input data applied through a mouse and/or an active pen, and may output the image data to the display module 2140. Alternatively, the processor 2110 may generate command data corresponding to the input data, and may output the command data to the camera module 2171 and/or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171, and/or the light module 2172 based on sensing data received from the sensor module 2161. For example, the processor 2110 may compare authentication data applied by the fingerprint sensor 2161-1 with authentication data stored in the memory 2120, and then may execute an application according to the comparison result. The processor 2110 may execute a command or output corresponding image data to the display module 2140 based on the sensing data sensed by the input sensor 2161-2 and/or the digitizer 2161-3. In a case where the sensor module 2161 includes a temperature sensor, the processor 2110 may receive temperature data from the sensor module 2161, and may further perform luminance correction on the image data based on the temperature data.

The processor 2110 may receive measurement data about the presence or absence of the user, the location of the user, and the user's line of sight from the camera module 2171. The processor 2110 may further perform luminance correction on the image data based on the measurement data. For example, after the processor 2110 determines the presence or absence of the user based on the input from the camera module 2171, the data conversion circuit 2112-2 and/or the gamma correction circuit 2112-3 may perform the luminance correction on the image data, and the processor 2110 may provide the luminance-corrected image data to the display module 2140.

At least some of the above-described components may be coupled mutually and communicate signals (e.g., commands and/or data) therebetween via an inter-peripheral communication scheme (e.g., a bus, general purpose input and output (“GPIO”), serial peripheral interface (“SPI”), mobile industry processor interface (“MIPI”), and/or ultra-path interconnect (“UPI”)). The processor 2110 may communicate with the display module 2140 via an agreed interface. Further, one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. For example, the electronic device 2101 may include at least one of a portable communication device (e.g., a smart phone), a computer device, a portable multimedia device, a portable medical device, a camera, a wearable device, or a home appliance. However, the electronic device 2101 according to one or more embodiments is not limited to the above-described devices.

The present disclosure may be applied to a display device and an electronic device including the same. For example, the present disclosure may be applied to a television (TV), a digital TV, a 3D TV, a smart phone, a wearable electronic device, a tablet computer, a mobile phone, a personal computer (PC), a home appliance, a laptop computer, a personal digital assistant (PDA), a portable multimedia player (PMP), a digital camera, a music player, a portable game console, a navigation device, etc. For example, the present disclosure may also be applied to a portable phone, VR device, electronic device for home use, and/or the like.

The foregoing is illustrative of embodiments and is not to be construed as limiting thereof. Although a few embodiments have been described, those skilled in the art will readily appreciate that many modifications are possible in the embodiments without materially departing from the novel teachings and scope of the present disclosure. Accordingly, all such modifications are intended to be included within the scope of the present disclosure as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims and their equivalents.

What is claimed is:

1. A pixel of a display device, the pixel comprising:
a first transistor comprising a gate connected to a first node, a first terminal configured to receive a first power supply voltage, and a second terminal connected to a second node;
a first capacitor comprising a first electrode configured to receive the first power supply voltage, and a second electrode connected to the first node;
a second capacitor comprising a first electrode connected to a third node, and a second electrode connected to the first node;
a second transistor configured to transfer a data voltage to the third node in response to a first signal;
a third transistor configured to connect the first node and the second node to each other in response to a second signal;
a fourth transistor configured to connect the first node and the third node to each other in response to a third signal;
a fifth transistor configured to transfer an initialization voltage to an anode of a light-emitting element in response to a fourth signal;
a sixth transistor configured to connect the second node and the anode of the light-emitting element to each other in response to a fifth signal; and
the light-emitting element comprising the anode, and a cathode configured to receive a second power supply voltage.

2. The pixel of claim 1, wherein, in an initialization period,
the initialization voltage is applied to the anode of the light-emitting element through the fifth transistor,
the initialization voltage is applied to the first node through the fifth transistor, the sixth transistor, and the third transistor, and
the initialization voltage is applied to the third node through the fifth transistor, the sixth transistor, the third transistor, and the fourth transistor.

3. The pixel of claim 1, wherein, in a threshold voltage compensation period,
the third transistor is configured to diode-connect the first transistor,
the first capacitor stores a threshold voltage of the first transistor,
the fourth transistor connects the first node and the third node to each other, and
the third node has a voltage equal to a voltage of the first node.

4. The pixel of claim 1, wherein, in a data writing period,
the second transistor is configured to apply the data voltage to the third node,
wherein the data voltage applied to the third node is divided by the first capacitor and the second capacitor, and
wherein the divided data voltage is transferred to the first node.

5. The pixel of claim 4, wherein an absolute value of the divided data voltage transferred to the first node is less than an absolute value of the data voltage applied to the third node.

6. The pixel of claim 4, wherein the divided data voltage is determined based on a capacitance of the first capacitor, a capacitance of the second capacitor, and the data voltage.

7. The pixel of claim 1, wherein the first, second, third, fourth, and sixth transistors are P-type metal-oxide-semiconductor transistors, and
wherein the fifth transistor is an N-type metal-oxide-semiconductor transistor.

8. The pixel of claim 1, wherein the first signal is a write signal,
wherein the second signal and the third signal are a same compensation signal,
wherein the fourth signal is an initialization signal, and
wherein the fifth signal is an emission signal.

9. The pixel of claim 8, wherein the second transistor comprises a gate configured to receive the write signal, a first terminal connected to a data line, and a second terminal connected to the third node,
wherein the third transistor comprises a gate configured to receive the compensation signal, a first terminal connected to the second node, and a second terminal connected to the first node,
wherein the fourth transistor comprises a gate configured to receive the compensation signal, a first terminal connected to the first node, and a second terminal connected to the third node,
wherein the fifth transistor comprises a gate configured to receive the initialization signal, a first terminal configured to receive the initialization voltage, and a second terminal connected to the anode of the light-emitting element, and
wherein the sixth transistor comprises a gate configured to receives the emission signal, a first terminal connected to the second node, and a second terminal connected to the anode of the light-emitting element.

10. The pixel of claim 8, wherein a frame period for the display device comprises:
an initialization period in which the anode of the light-emitting element, the first node, and the third node are initialized;
a threshold voltage compensation period in which a threshold voltage of the first transistor is stored in the first capacitor;
a data writing period in which the data voltage is provided through a data line; and
an emission period in which the light-emitting element is configured to emit light.

11. The pixel of claim 10, wherein, in the initialization period,
the initialization signal and the write signal have a high level,
the emission signal and the compensation signal have a low level,
the third and fourth transistors are turned on in response to the compensation signal having the low level,
the fifth transistor is turned on in response to the initialization signal having the high level,
the sixth transistor is turned on in response to the emission signal having the low level,
the anode of the light-emitting element is initialized based on the initialization voltage transferred through the fifth transistor,
the first node is initialized based on the initialization voltage transferred through the fifth transistor, the sixth transistor, and the third transistor, and
the third node is initialized based on the initialization voltage transferred through the fifth transistor, the sixth transistor, the third transistor, and the fourth transistor.

12. The pixel of claim 10, wherein, in the threshold voltage compensation period,
the emission signal, the initialization signal, and the write signal have a high level,
the compensation signal has a low level,
the third and fourth transistors are turned on in response to the compensation signal having the low level,
the fifth transistor is turned on in response to the initialization signal having the high level,
the third transistor is configured to diode-connect the first transistor such that the threshold voltage of the first transistor is stored in the first capacitor,
the fourth transistor connects the first node and the third node to each other such that the third node has a voltage equal to a voltage of the first node, and
the fifth transistor is configured to apply the initialization voltage to the anode of the light-emitting element.

13. The pixel of claim 10, wherein, in the data writing period,
the emission signal, the initialization signal, and the compensation signal have a high level,
the write signal has a low level,
the second transistor is turned on in response to the write signal having the low level,
the fifth transistor is turned on in response to the initialization signal having the high level,
the second transistor is configured to apply the data voltage to the third node,
the data voltage applied to the third node is divided by the first capacitor and the second capacitor such that the divided data voltage is transferred to the first node, and
the fifth transistor is configured to apply the initialization voltage to the anode of the light-emitting element.

14. The pixel of claim 10, wherein, in the emission period,
the compensation signal and the write signal have a high level,
the emission signal and the initialization signal have a low level,
the sixth transistor is turned on in response to the emission signal having the low level,
the first transistor is configured to generate a driving current based on a voltage of the first node,
the sixth transistor is configured to transfer the driving current generated by the first transistor to the light-emitting element, and
the light-emitting element is configured to emit light based on the driving current.

15. The pixel of claim 1, wherein the first signal is a write signal,
the second signal is a compensation signal,
the third signal is a reference signal that is different from the compensation signal,
the fourth signal is an initialization signal, and
the fifth signal is an emission signal.

16. The pixel of claim 1, further comprising:
a seventh transistor connected between the second node and the sixth transistor, and configured to operate as an active load in response to a direct-current (DC) voltage,
wherein the seventh transistor comprises a gate configured to receive the DC voltage, a first terminal connected to the second node, and a second terminal connected to the sixth transistor.

17. The pixel of claim 1, further comprising:
an eighth transistor that is diode-connected between a line that is configured to transfer the first power supply voltage and the first terminal of the first transistor.

18. A display device comprising:
a display panel comprising a plurality of pixels;
a data driver configured to provide a data voltage to each of the plurality of pixels;
a scan driver configured to provide a write signal, a compensation signal, and an initialization signal to each of the plurality of pixels;
an emission driver configured to provide an emission signal to each of the plurality of pixels; and
a controller configured to control the data driver, the scan driver, and the emission driver,
wherein each of the plurality of pixels comprises:
a first transistor comprising a gate connected to a first node, a first terminal configured to receive a first power supply voltage, and a second terminal connected to a second node;
a first capacitor comprising a first electrode configured to receive the first power supply voltage, and a second electrode connected to the first node;
a second capacitor comprising a first electrode connected to a third node, and a second electrode connected to the first node;
a second transistor configured to transfer the data voltage to the third node in response to the write signal;
a third transistor configured to connect the first node and the second node to each other in response to the compensation signal;
a fourth transistor configured to connect the first node and the third node to each other in response to the compensation signal;
a fifth transistor configured to transfer an initialization voltage to an anode of a light-emitting element in response to the initialization signal;
a sixth transistor configured to connect the second node and the anode of the light-emitting element to each other in response to the emission signal; and
the light-emitting element comprising the anode, and a cathode configured to receive a second power supply voltage.

19. An electronic device comprising:
a processor configured to provide input image data; and
a display device comprising a plurality of pixels, and configured to drive the plurality of pixels based on the input image data,
wherein each of the plurality of pixels comprises:
a first transistor comprising a gate connected to a first node, a first terminal configured to receive a first power supply voltage, and a second terminal connected to a second node;
a first capacitor comprising a first electrode configured to receive the first power supply voltage, and a second electrode connected to the first node;
a second capacitor comprising a first electrode connected to a third node, and a second electrode connected to the first node;
a second transistor configured to transfer a data voltage to the third node in response to a first signal;
a third transistor configured to connect the first node and the second node to each other in response to a second signal;
a fourth transistor configured to connect the first node and the third node to each other in response to a third signal;
a fifth transistor configured to transfer an initialization voltage to an anode of a light-emitting element in response to a fourth signal;
a sixth transistor configured to connect the second node and the anode of the light-emitting element to each other in response to a fifth signal; and
the light-emitting element comprising the anode, and a cathode configured to receive a second power supply voltage.

20. The electronic device of claim 19, wherein, in a data writing period,
the second transistor is configured to apply the data voltage to the third node,
wherein the data voltage applied to the third node is divided by the first capacitor and the second capacitor, and
wherein the divided data voltage is transferred to the first node, and
wherein an absolute value of the divided data voltage transferred to the first node is less than an absolute value of the data voltage applied to the third node.
